(19) United States
(12) Patent Application Publication
(10) Pub. No.: US 2004/0139470 A1
(43) Pub. Date: Jul. 15, 2004

(54) Method and apparatus for surveillance

(76) Inventor: Richard Treharne, Oxfordshire (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/473,916

(22) PCT Filed: Mar. 28, 2002
(86) PCT No.: PCT/GB02/01524

(30) Foreign Application Priority Data
Apr. 4, 2001 (GB) 0108389.8

(51) Int. Cl. H04N 7/18

(52) U.S. Cl. 725/105; 348/143; 348/148

(57) ABSTRACT

A method of surveillance wherein a scanning device such as a digital camera located at a monitoring location is directed towards a target region to be subject to surveillance; and the target region is scanned by way of the scanning device to generate output information representing information associated with the target region; characterized by the steps of: transmitting output information from the scanning device to a receiving method at a receiving location by way of a communication network which can include the Internet; reviewing at the receiving location, or at a location in communication therewith, the output information such as by comparison with information contained in a database; and sending from the receiving location or a location in communication with the receiving location by way of the communicating network to at least one decision making location (which can included the monitoring location) a signal representing information relating to or arising from the output information.

### TECHNICAL FIELD

This invention relates to method and apparatus for surveillance.

### BACKGROUND ART

European Patent Application EP-A-741,377 discloses a system for monitoring road traffic to determine when driving laws are broken, e.g., to detect speeding, driving through red lights, driving to close for safety etc. Objects, e.g., vehicles are monitored by an object sensor. Output signals are generated as actual values in dependence on sensed movement or positions. The actual values are processed in n analysis unit connected to the object sensor and are compared with predetermined target or threshold values. A deviation of the actual value from the target or threshold value indicates that a rule or law has been broken and a trigger signal is generated. The trigger signal causes a camera to record an image of the object together with data on the law broken. In the case that a law is broken, the recorded image together with the corresponding data is transmitted as electric data signals via a data connection to a receiving station. The latter is remotely situated from the object sensor and the analysis unit. The transmitted data is stored and/or further analysed at the receiving station.

The above monitoring system, conveniently described as a batch process, is useful for the provision of evidence in legal proceedings. However it is not readily suitable for surveillance purposes where a continuous monitoring process is to be preferred.

### DISCLOSURE OF INVENTION

According to a first aspect of the present invention there is provided a method of surveillance wherein a scanning device, such as a digital camera, located at a monitoring location is directed towards a target region to be subject to surveillance; and the target region is scanned by means of the scanning device to generate output information representing information associated with the target region; characterised by the steps of: transmitting output information from the scanning device to a receiving method at a receiving location by way of a communication network which can include the Internet; reviewing at the receiving location, or at a location in communication therewith, the output information such as by comparison with information contained in a database; and sending from the receiving location or a location in communication with the receiving location by way of the communicating network to at least one decision making location (which can included the monitoring location) a signal representing information relating to or arising from the output information can information associated with the target region characterized by mounting of the scanning device on the self-propelled vehicle; transmitting output information from the scanning device to a receiving means at a receiving location by way of a communication network which can include the Internet; reviewing at the receiving location, or at a location in communication therewith, the output information by comparison with information contained in a database; looking for a correspondence between the output information and data contained in the database, and sending from the receiving location or a location in communication with the receiving location by way of the communicating network to the monitoring location a signal representing such a correspondence between the output information and data contained in the database information relating to or arising from the output information.

According to a first preferred version of the first aspect of the present invention, the method is further characterized by a locating step involving the mounting of the scanning device in a portable carrier such that the target region can be varied by movement of the carrier.

According to a second preferred version of the first aspect of the present invention or of the first preferred version thereof, the method of surveillance is further characterized in that the output information comprises information providing at least one of the following: an image, data, a message, targets profile or any combination or sequence thereof.

According to a third preferred version of the present invention or of any preceding preferred version thereof, the method of surveillance is further characterized by an additional step of establishing parameters associated with the specified steps, such as location of the monitoring location by satellite positioning or radio positioning.

According to a second aspect of the present invention, there is provided apparatus for surveillance comprising: a scanning device, such as a digital camera, locatable at a monitoring location for scanning a target region, and a transmitting means for conveying output information from the scanning device which output is information derived from the target region which means utilizes a communication network which can include the Internet; characterized by locating of the scanning device on a self propelled vehicle, whereby the target region to be scanned by means of the scanning device can be varied by movement of the vehicle; receiving means at a receiving location for receiving the output information or a derivative thereof as a transmitted signal from the monitoring location; reviewing means at the receiving location, or at a location in communication therewith, to enable the transmitted signal or a derivatives thereof to be received and compared with information contained in a database or other data storage system; and transmitting means at the receiving location or in communication therewith for transmitting to at least one decision making location (which can included the monitoring location) a signal representing correspondence between the output information and data contained in the database relating to or arising from the output information.

According to a first preferred version of the second aspect of the present invention, the apparatus is further characterized in that the scanning device adapted for location in a mobile carrier whereby the target region to be scanned by means of the scanning device can be varied by movement of the carrier.

According to a second preferred version of the second aspect or of the first preferred version thereof, the apparatus is further characterized in that the output information comprises information relating to at least one of the following: an image, data, a message, target profile or any combination or sequence thereof.

The present invention provides for a wide range of options to be exercised in real time relating an event detected in one location to be readily considered at that location or elsewhere and compared with stored data so that the event can be swiftly categorised and remedial or other action taken swiftly. Where the required target or other data is stored relative to the scanning location can vary as long as the stored material is readily recoverable by an available communication channel. For example, the data storage can be in a mobile system or on a centralized database. Likewise a variety of channels can be used such as radio, microwave, optical, by way of networks (including Internet) or combinations involving these.

Preferably the invention is intended to provide for relatively automatic operation. Thus in mobile applications the system will scan the region (usually in front of a vehicle or other carrier of the scanning device) continuously and transmit resulting information arising from the target area to the receiving area for comparison with, or other evaluation by way of, a database. A correspondence between the output information and information from the database results in a return signal being despatched to be received at the monitoring location that a target has been identified. This fact can not only be displayed at the monitoring location but also emphasized by means of a distinctive output (such as a sound or visual signal) drawing attention to the fact of target identification. In addition given that a significant time period has passed between the scanning action of a target and the subsequent identification of the target then the vehicle mounted installation can include means to relate the likely location of the target relative to events (such as the length of time or the passage of non-significant targets) that have occurred between the scanning signal and the return signal identifying the target.

### BRIEF DESCRIPTION OF DRAWINGS

Exemplary embodiments of the invention will now be described with reference to the accompanying diagrams of surveillance systems of which:

FIG. 1 is of a first embodiment;

FIG. 2 is of a second embodiment;

FIG. 3 is of a third embodiment;

FIG. 4 is of a fourth embodiment; and

FIG. 5 is of a fifth embodiment;

In each figure, two bounded areas are shown. That on the left hand side shows a mobile video system incorporating a scanning device (typically a digital camera). That on the right hand side shows a type of central database system. The two sides are linked to exchange information by way of a telemetry system.

### MODES FOR CARRYING OUT THE INVENTION

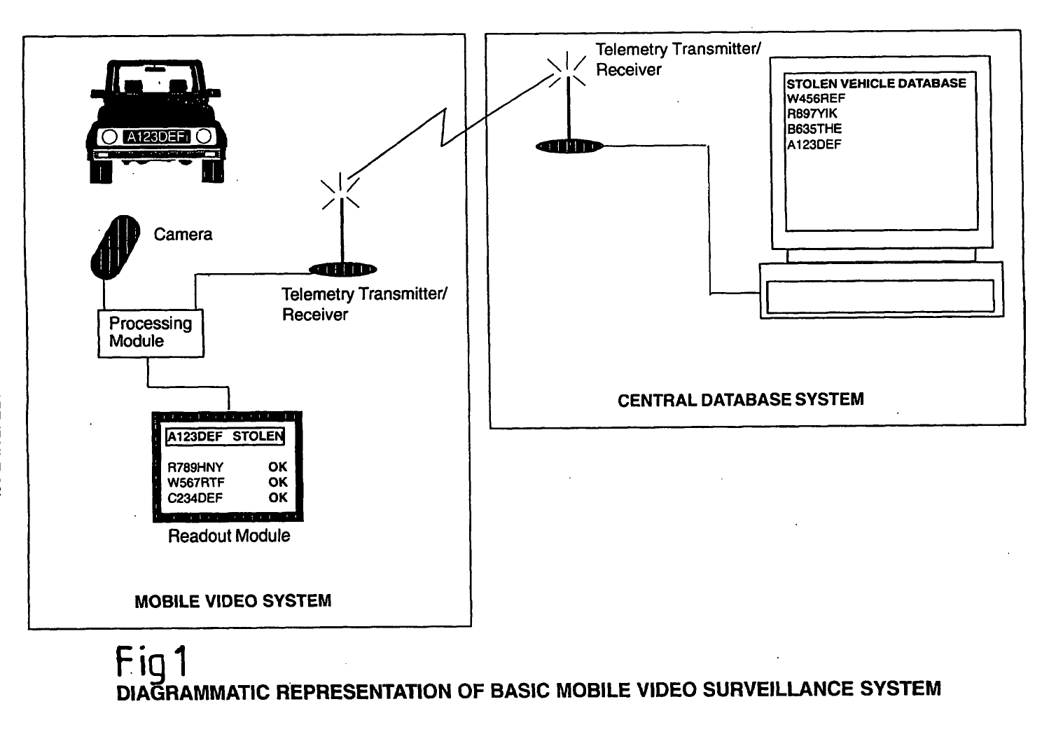

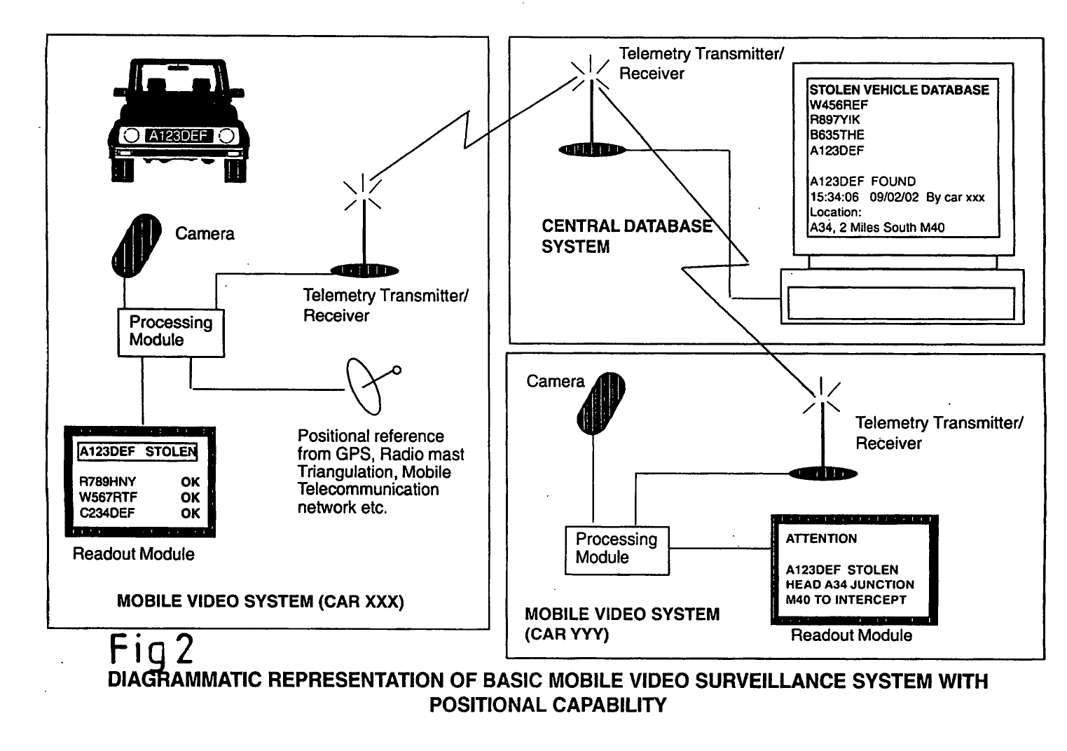

FIG. 1

This shows a basic mobile video surveillance system with a digital camera located in a car and facing forward. The installation also includes a wireless telemetry link for communicating with a central database system.

With the car forming a member of a queue of moving traffic, a target area in front of the car is continuously scanned. While the target area is occupied by another vehicle its number plate is scanned along with other information about the occupant of the target area such as the colour or other distinguishing material. Output information as to the target area is fed from the camera to a local readout module (so enabling the output of the camera to be reviewed locally). In addition, the output information from the camera is transmitted from the installation by way of a telemetry link to the central database system.

In this case, the data base system contains a current list of stolen vehicle registration numbers. In the event information from the static camera transmitted to the central database correspond to the identity of a stolen vehicle listed on the database then the database system provides for this information to be transmitted back to the camera installation to enable action to be taken locally, if desired.

In the event an occupying vehicle of the target area is identified as being of significance for some reason then the monitoring vehicle or its occupants or contents can be kept under observation without arousing suspicion.

FIG. 2

This second embodiment includes the features of the first embodiment of FIG. 1 with the addition of a positional capability (such as a satellite positional system) so that the location of the camera vehicle can be readily established so as to enable position of the camera vehicle (and so of a suspect vehicle being scanned ) can be readily established and transmitted not only to the camera car but to other another vehicle or center likely to be needed to participate in any required action following the identification of the suspect.

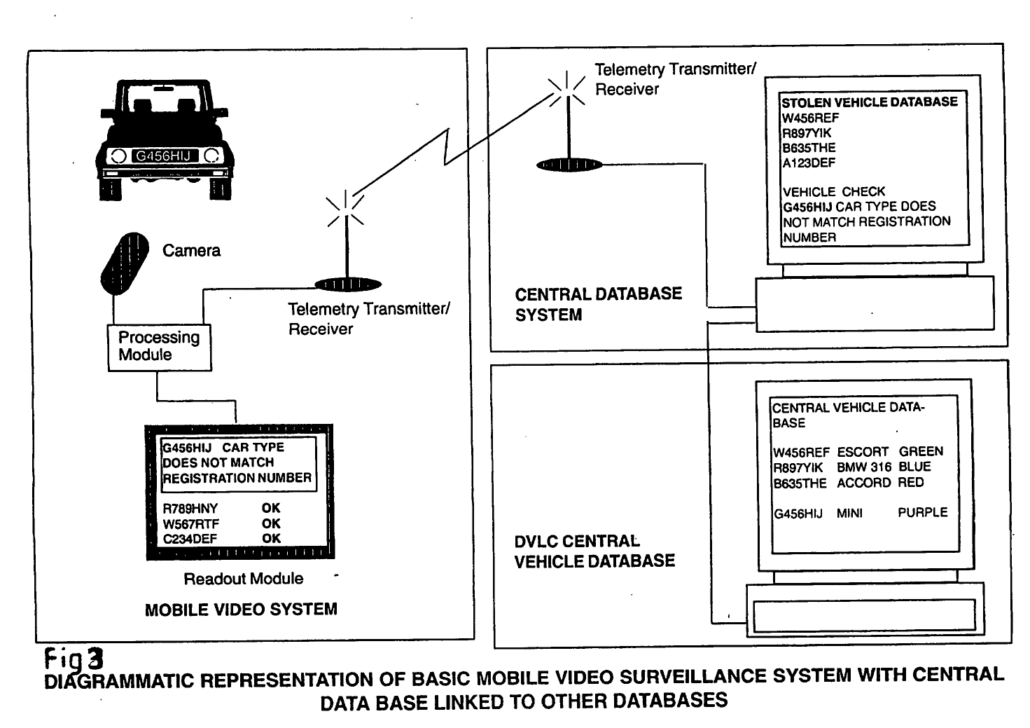

FIG. 3

This third embodiment includes the features of the first embodiment of FIG. 1 with the addition of a link between the central database system and the national vehicle licensing center so that information relating to a vehicle identified by means of the camera can be exchanged as required.

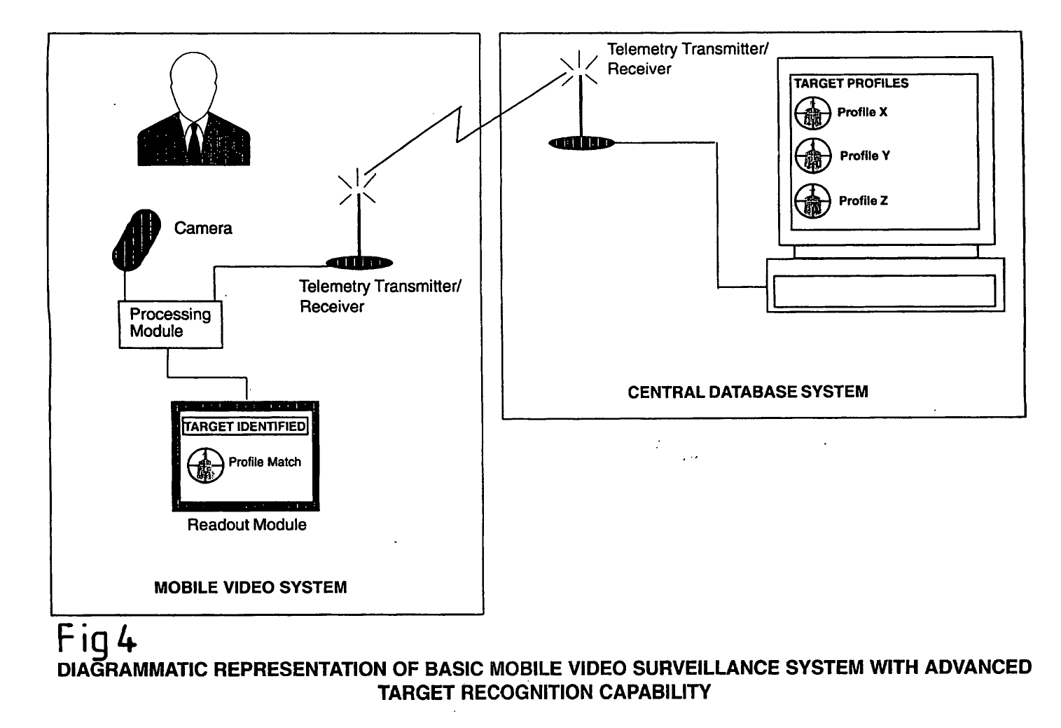

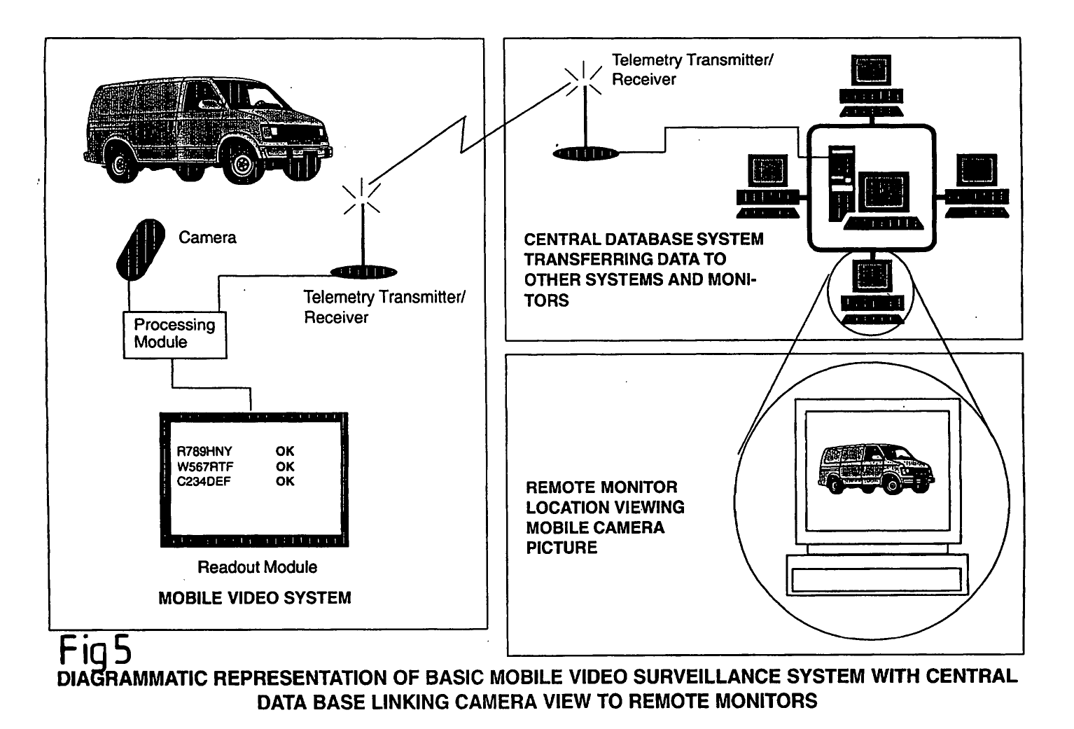

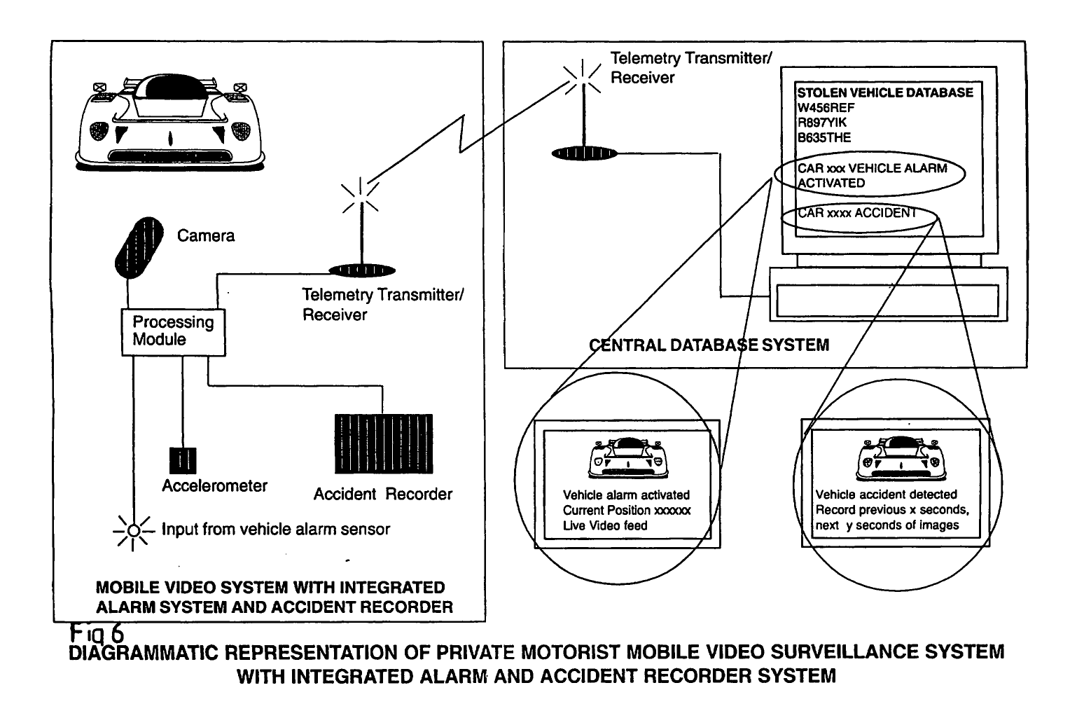

FIG. 4

This fourth embodiment shows a system including features of the first embodiment, as far as the mobile side of the system is concerned. However, in this case the mobile camera is being used to scan images of vehicles, typically from the side. The camera information is processed and transmitted by a telemetry link to a central database system. Apart from the central database system being used to review or analyze the image and color information in this case, it is served to transmit material, or information based on it, to other data processing systems or information handling or analyzing locations and to display monitors. In this case, output information from the camera relates to shapes and colors and these can involve static or moving target objects.

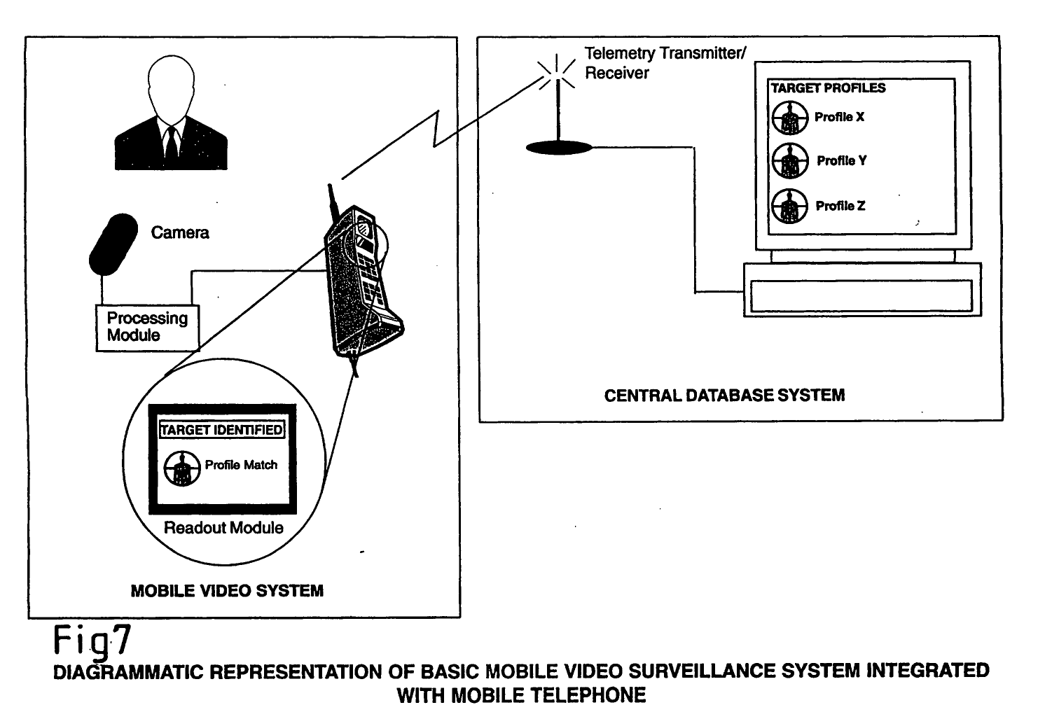

FIG. 5

This fifth embodiment shows a surveillance system made up of a camera installed in a private car which, in addition to a data processing module and one end of a telemetry link, it also includes sensors, stored information, data processing means and sensors or other information relating to functions or actions relating to the vehicle. Typically the on-board system can be used to transmit information of failure, incorrect operation or anomalous behavior by the car. The installation can be used to transmit significant information to a central database system (operated, for example, by security or insurance organizations). In addition, the camera can be incorporated in a “black-box” system as used on aircraft. In this the on-board system in the car serves to continuously record, say, the field scanned by the camera and data provided by one or more sensors. This can be undertaken for a period so that subsequent investigation can recover information both before and after an occurrence of a pre-determined event (such as an impact or the occurrence of non-standard car operation).

The embodiments describe various data processing steps that can be incorporated in a surveillance system so that a monitoring step undertaken by the scanning device results in target identification. Further data handling can be provided for by other inputs. Thus a satellite positioning input can be entered into the system to provide for the position of the monitoring location to be recorded and/or identified at all times or at least while surveillance is being undertaken to enable the location of the monitoring region to be recorded in relation to other events (real time) events such as target identification. Radio positioning can also be used.

### INDUSTRIAL APPLICABILITY

The embodiments provide for processes of comparison can be carried out using an appropriate software application among a number now available. The flexibility of the systems described for the embodiments and the use of a variety of communication links and data handling units readily provides for the comparison step to be carried out at the location with the best resources for undertaking it. Thus the fact of the scanning end of the various arrangements usually being in a mobile form does not prevent the comparison process being undertaken on a database system situated elsewhere. The central system can receive new or updating information from other sources to ensure that relevant and up-to-date information is available for the monitoring end of the network. In addition, the central system can be used to distribute information from the camera or other items of information at the front end of the system to other locations for comparison, analysis or executive decision making.

The invention can also be applied for apparatus and methods so as to enable an opportunity to be taken to take advantage of existing national, international and internet network systems.

1 A method of surveillance wherein a scanning device, such as a digital camera, can scan a target region to generate output information representing information associated with the target region; characterised by:
mounting of the scanning device on the self-propelled vehicle:
transmitting output information from the scanning device to a receiving means at a receiving location by way of a communication network which can include the Internet;
reviewing at the receiving location, or at a location in communication therewith, the output information by comparison with information contained in a database, looking for a correspondence between the output information and data contained in the database; and
sending from the receiving location or a location in communication with the receiving location by way of the communicating network to the monitoring location a signal representing such a correspondence between the output information and data contained in the database relating to or arising from the output information.

2 A method as claimed in claim 1 characterised by a locating step involving the mounting of the scanning device in a portable carrier such that the target region can be varied by movement of the carrier.

3 A method of surveillance as claimed in any preceding characterised in that the output information comprises information providing at least one of the following: an image, data, a message, targets profile, or any combination or sequence thereof.

4 A method of surveillance as claimed in any preceding claim characterised by an additional step of establishing parameters associated with the specified steps, such as location of the monitoring location, by satellite positioning or radio positioning.

5 Apparatus for surveillance comprising: a scanning device, such as a digital camera, locatable at a monitoring location for scanning a target region; and a transmitting means for conveying output information from the scanning device which output is information derived from the target region which means utilises a communication network which can include the Internet; characterised by:
locating of the scanning device on a self propelled vehicle, whereby the target region to be scanned by means of the scanning device can be varied by movement of the vehicle.
receiving means at a receiving location for receiving the output information or a derivative thereof as a transmitted signal from the monitoring location;
reviewing means at the receiving location, or at a location in communication therewith, to enable the transmitted signal or a derivatives thereof to be received and compared with information contained in a database or other data storage system; and
transmitting means at the receiving location or in communication therewith for transmitting to at least one decision making location (which can included the monitoring location) a signal representing correspondence between the output information and data contained in the database relating to or arising from the output information.

6 Apparatus as claimed in claim 5 characterised in that the scanning device is adapted for location in a mobile carrier whereby the target region to be scanned by means of the scanning device can be varied by movement of the carrier.

7 Apparatus as claimed in claim 5 or 6 characterised in that the output information comprises information relating to at least one of the following: an image, data, a message, target profile, or any combination or sequence thereof.
